(19) United States
(12) Patent Application Publication
(10) Pub. No.: US 2010/0224563 A1
(43) Pub. Date: Sep. 9, 2010

(54) Polyamide nanofiltration membrane useful for the removal of phospholipids

(76) Inventors: Kripal Singh, Bhavnagar (IN); Virendrakumar Jayantilal Shah, Bhavnagar (IN)

Correspondence Address: ABELMAN, FRAYNE & SCHWAB, 666 THIRD AVENUE, 10TH FLOOR, NEW YORK, NY, 10017, US

(21) Appl. No.: 12/587,046

(22) Filed: Sep. 30, 2009

Related U.S. Application Data
(62) Division of application No. 11/986,805, filed on Nov. 26, 2007, now abandoned.

(30) Foreign Application Priority Data
Nov. 26, 2006 (IN) 2543/DEL/2006

(51) Int. Cl. B01D 61/14; B05D 3/02

(52) U.S. Cl. 210/651; 427/374.1

(57) ABSTRACT

The present invention provides a polyamide nanofiltration membrane and the process for the preparation thereof thereof. The invention further provides a process for the removal of phospholipids from rice bran oil (edible grade) by using novel polyamide membrane. The oil permeated through the membrane is 90 to 95% free from phospholipids in comparison to feed oil with about 90% reduction of color in comparison to feed oil.

### FIELD OF THE INVENTION

The present invention relates to a polyamide nanofiltration membrane. Particularly the present invention relates to a polyamide nanofiltration membrane useful for degumming the rice bran oil (edible grade) by nanofiltration. The present invention also provides a process for the preparation of polyamide nanofiltration membrane.

### BACKGROUND OF THE INVENTION

Vegetable oils are recovered from oil seeds or oil-bearing materials. Rice bran oil is recovered from rice husk. Crude rice bran oil contains few undesirable components in minor proportion such as phospholipids, free fatty acids, pigments, odorous compounds etc. These components effect adversely the stability and quality of oil and presence of these components make the oil unfit for cooking; therefore these are removed from oil by a multi-step complex process called refining. Phospholipids are required to be removed first, because phospholipids being emulsifier posses' serious problems during subsequent stages of refining process and would result in excessive oil loss and poor quality of refined oil. Hence first step of multi-step complex conventional chemical refining process, is degumming in which phospholipids are removed from the oil. Phospholipids are of two types hydratable and non-hydratable. In the conventional degumming process hydratable phospholipids are removed by hydration of oil by steam followed by agitation and centrifugation of oil. The non-hydratable phospholipids are removed by the treatment of oil with phosphoric acid or citric acid. The amount of acid required varies depending upon the phospholipids content of the oil. Other method to refine vegetable oil is physical method in which oil is heat treated under vacuum to strip off free fatty acids, odorous compounds, etc. However to apply physical refining method, phospholipids contents of oil should be as low as 10 to 20 ppm. Therefore degumming operation is inevitable in oil refining process. To refine the rice bran oil by physical refining process the removal of phospholipids from oil to a very low level is necessary otherwise presence of phospholipids would create problems during refining process and would result in excessive oil loss and poor quality of refined oil. To achieve desired concentration of phospholipids in oil by conventional degumming process is difficult. Presently, a need exists to improve the quality of refined oil with respect of phospholipid content, such that the desired concentration of phospholipids is maintained in oil by membrane process.

Reference may be made to U.S. Pat. No. 4,062,882 (1997) to A. K. S. Gupta et al. reveals the process of refining crude glyceride oil by a combination of ultrafiltration and gel percolation through the column herein oil is mixed with non-aqueous solvent and then ultrafiltered through semi permeable membrane, ultrafiltered oil is then percolated through the column. The drawback of the process is that the capacity of the percolation column is very low and column requires very frequent regeneration.

U.S. Pat. No. 4,409,354 (1998) to A. K. S. Gupta et al. discloses the process of refining crude glyceride oil by membrane filtration, especially for removal of phospholipids from soybean oil. The process includes diluting the oil with non-acidic and non-alcoholic organic solvent and separating the solvent after membrane filtration. The drawback of the process is the addition of the solvent to the oil and later separating it from the solvent makes the process more complex. This adds one more unit step to the oil refining process, which does not have any beneficial effect.

U.S. Pat. No. 4,414,157 (1983) to A. Iwama et al. discloses a process for the purification of crude glyceride oil compositions using capillary semipermeable membranes followed by tubular semipermeable membranes. The drawback of the process is that it is a two stage process involving first passing miscella through capillary membrane and then passing the concentrated miscella through a tubular semipermeable membrane.

U.S. Pat. No. 4,545,940 (1985) to Y. Mutoh et al. discloses the dewaxing of vegetable oil by cooling it to 10° C. allowing the wax to crystallize, followed by ultrafiltration of the oil through tubular membrane in the temperature range of 10 to 20° C. They claim that, in addition to waxes it can also reduce the phospholipids and free fatty acids. The drawback of the process is to cool the miscella to 10° C. below room temperature and then passing the miscella through tubular membrane. Cooling the oil miscella and then filtering through the membrane would chock the membrane due to entrapment of the wax crystals in the membrane pores. This would result in low productivity and would require frequent membrane cleaning and washing.

U.S. Pat. No. 4,787,981 (1988) to S. Tanashi, et al discloses a process for purification of crude glyceride oil compositions which comprises diluting crude glyceride oil containing gums and waxes with an organic solvent and contacting the diluted oil composition with a semi-permeable polyimide membrane in a tubular form in side the glass tube. The drawback of this process is that the tubular configuration of the membrane has very low packing hence productivity of the tubular configuration is comparatively less.

U.S. Pat. No. 5,310,487 (1994) to Rochem Separation Systems, Inc., Torrance, Calif. discloses a method of refining edible oils by membrane technology, which involves treating oil and solvent mixture in a membrane module system. The workers have used oil miscella (a mixture of oil and organic solvent such as hexane) as feed oil for membrane process. The main disadvantage of the method is the use of oil miscella.

### OBJECTS OF THE INVENTION

The main object of the present invention is to provide a polyamide nanofiltartion membrane.

Another object is to provides a process for the preparation of polyamide nanofiltartion membrane.

Yet another object is to provide a process to remove phospholipids from rice bran oil.

Yet another object of the present invention is to develop a membrane based method for removing gums and waxes from rice bran oil without adding solvent to the oil.

Yet another object of the present invention is to develop an energy efficient, eco-friendly, one step degumming process for refining edible oils.

Yet another object is to develop a membrane process for degumming rice bran oil without diluting it with solvent.

Still another object of the present invention is to provide a process of degumming the rice bran oil with substantially reducing the loss of oil entrapped in degumming residue.

The present invention would not require the preparation of miscella (mixture of oil and non-aqueous solvent) and later recovery of solvent after membrane processing of miscella. Further the process it does not required steps likes alkali treatment, de-colorization of oil etc.

### SUMMARY OF THE INVENTION

Accordingly, the present invention provides a polyamide nanofiltration membrane comprising a polyamide layer coated ultrafiltration membrane, characterized in that the said polyamide layer is a polymer of amine and trimeosyl chloride having a thickness in the range of 500 to 1600 Å.

In an embodiment of the present invention the ultrafiltration membrane used is selected from the group consisting of polysulfone, polyethersulfone, polyvinylidienefluoride, polycarbonate and polyamide UF membrane.

In another embodiment the ultrafiltration membrane used has a thickness in the range of 20 to 60 microns.

In yet another embodiment of the present invention the monomer used for polymerization with trimeosyl chloride is selected from metaphenylene diamine, piperazine and a mixture thereof.

In yet another embodiment of the present invention the characteristics of the nanofiltration membrane are:
a) the polyamide layer has a thickness in the range of 500 to 1600 Å,
b) permeability of nanofiltration membrane for rice bran oil is in the range of 0.8 to 5 gallon per square feet membrane area per day.

In yet another embodiment the nanofiltration membrane obtained is used for the removal of about 90% phospholipids from rice bran oil.

The present invention further provides a process for the preparation of polyamide nanofiltration membrane comprising the steps of:
a) impregnating the ultrafiltration membrane in 1-2% aqueous solution of a monomer for about 60 seconds, removing the impregnated UF membrane from the solution mixture and draining the excess solution from the said UF membrane for about 60 seconds to retain the desired amount of monomer,
b) dipping the above said monomer coated UF membrane into a 0.004 to 0.006% non aqueous solution of trimeosyl chloride for polymerization for a period of about 60 seconds, removing the resultant polymer coated UF membrane from the solution mixture and draining the excess solution for about 60 seconds, followed by drying for about 5 minutes and curing by heating at a temperature of 60-70° C. for about 5 minutes, cooling the resultant membrane and soaking it in water for about 24 hours to obtain the desired product.

In yet another embodiment of the present invention the ultrafiltration membrane used in step (a) is selected from the group consisting of polysulfone, polyethersulfone, polyvinylidienefluoride, polycarbonate and polyamide UF membrane.

In yet another embodiment the ultrafiltration membrane used in step (b) has a thickness in the range of 20 to 60 microns.

In yet another embodiment the nanofiltration membrane obtained has a thickness in the range of 500 to 1600 Å.

In yet another embodiment the nanofiltration membrane obtained is useful for the removal of 90 to 95% of phospholipids from the rice bran oil.

In yet another embodiment the nanofiltration membrane obtained is useful for the removal of 80-90% pigments from the rice bran oil.

The present invention further provides a process for the removal of phospholipids from the rice bran oil by using polyamide nanofiltration membrane which comprises, feeding the rice bran oil without diluting with aqueous or non aqueous solvent to a nanofiltration membrane, at a flow rate of 0.8 to 5 gallon per square feet/day, at a pressure of 300 to 600 psi, at a temperature of about 25 to 30° C. to obtain the desired 90 to 95% phospholipids free rice bran oil.

In yet another embodiment of the invention the nanofiltration membrane used comprises a polyamide layer coated ultrafiltration membrane characterized in that the said polyamide layer is a polymer of amine and trimeosyl chloride having a thickness in the range of 500 to 1600 Å.

In still another embodiment of the invention the ultrafiltration membrane used is selected from the group consisting of polysulfone, polyethersulfone, polyvinylidienefluoride, polycarbonate and polyamide UF membrane.

In still another embodiment the ultrafiltration membrane used has a thickness in the range of 20 to 60 microns.

### DETAILED DESCRIPTION OF THE INVENTION

The present invention provides a method of removing phospholipids from rice bran oil (edible grade having free fatty acid value less than 5%) by membrane process to achieve very low level of phospholipids content in the processed rice bran oil so as to refine the rice bran oil subsequently by physical refining method, the method comprises feeding the rice bran oil without diluting by any aqueous or non-aqueous solvent to a membrane processing unit having a semipermeable membrane, the oil passes through the membrane is collected as permeate oil and the oil does not passes through the membrane is collected as concentrate oil, membrane permeated oil contains less phospholipids in comparison to the feed oil and concentrate oil which contains increased concentration of phospholipids than the feed oil, the membrane used was a nanofiltration membrane in flat sheet configuration, the membrane was made from polymer materials such as Polysulfone, Polyethersulfone, Polyvinylidieneflouride, Polycarbonate etc., by phase inversion technique, subsequently this membrane was coated with polyamide polymer layer by in-situ interfacial polymerization of a diamine with a di or tri carboxylic acid chloride, membrane was post cured to achieve desired properties, membrane was pretreated with various solvents such as isopropyl glycol, propylene glycol, methanol etc. The oil permeation experiments were conducted on RO test kit having four cells in a series. The rice bran oil (edible grade) having free fatty acids value less than 3% is treated by membrane process to remove phospholipids from the oil. The feed oil was passed through the membrane once. Membrane permeated oil has >90% less phospholipids compare to feed oil. The feed oil was passed through the membrane at 300 psi to 600 psi trans membrane pressure. Membrane permeated oil has >90% less phospholipids and ˜90% less color compare to feed oil compare to feed oil.

The oil was feed to the membrane unit at a temperature in the range of 30° C. to 60° C., there was no change in the separation of phospholipids and color from the oil. The permeate collection rate increases from 100 ml/min. to 125 ml/min at 60° C. and the oil was feed to the membrane unit at pressures in the range of 300 psi to 600 psi.

The method of degumming rice bran oil (edible grade) by membrane process to achieve very low level of phospholipids content in the degummed oil so as to refine the oil subsequently by physical refining method includes feeding the rice bran oil without diluting it by any of aqueous or non-aqueous solvent to a membrane processing unit having a semi-permeable membrane and to collect permeate oil and concentrate oil. The oil passes through the membrane is collected as permeate oil. It contains less phospholipid in comparison to the feed oil. And the oil, which does not pass through the membrane, is collected as concentrate oil, which contain increased concentration of phospholipids than the feed oil. The membrane used was a nanofiltration membrane in flat sheet configuration. The membrane is made from polymer materials such as Polysulfone, Polyethersulfone, Polyvinylidieneflouride, Polycarbonate etc., by phase inversion technique, subsequently membrane was coated with polyamide polymer by in-situ interfacial polymerization of a diamine with a di or tri carboxylic acid chloride to make nanofiltration membrane, freshly prepared nanofiltration membrane was post cured in hot air oven to achieve desired properties. Membrane was treated with various solvents for further modification before permeation experiments. The oil permeation experiments were conducted on RO test kit having four cells in a series, figure of Reverse Osmosis test kit used for conducting the experiment is given as a FIG. 1. The pressure applied to the test kit varies from 300 psi to 600 psi. The oil was feed to the test kit at different rate varies from 300 ml per minute to 800 ml per minute. Temperature of the feed oil varies from 30° C. to 60° C., permeate oil was collected at a different rates varies from 30 liter per meter square per day (Imd) to 80 Imd depending upon the test pressure. The feed oil was passed through the membrane once. The feed oil, permeate oil and concentrate oil samples were analyzed for phospholipids and free fatty acids values in accordance with American Oil Chemists Society Methods Ca 12-55, Cd 3a-63 respectively. The color of the samples was examined by Lovibond tintometer in accordance to The Japan Oil Chemists Society Method 2.3.1b-71.

As stated in prior art, in the usual method of processing vegetable oils by membrane process, the crude oil is mixed with organic solvents such as hexane, acetone, propanol etc., then oil solvent mixture (miscella) is treated with the membrane and later solvent is removed from the treated oil solvent mixture. The present invention obviates the preparation of miscella by mixing oil with organic solvent before processing the oil and then to recover the solvent after processing of oil. The present invention provides a method of degumming the oil without treating oil with any chemicals such as phosphoric acid, sulphuric acid etc. The invention present a method to prepare the rice bran oil for subsequent refining by physical refinnig method first an ultrafiltration membrane was fabricated from polymer materials such as Polysulfone, Polyethersulfone, Polyvinylidieneflouride, Polycarbonate, Polyamide etc. by phase inversion technique. In this technique solution of above-mentioned polymers containing 12 to 18% w/w in aprotic solvents such as dimethylformamide, N, N dimethylacetamide etc. was spread on non-woven polyester support in uniform thickness the support was then dipped in coagulation bath containing 2% aqueous solution of dimethylformamide after specified time varies from 10-40 seconds, more precisely 18% solution of polyamide polymer namely Nomex. in N,N dimethylacetamide was used for fabrication of ultra filtration membrane evaporation time 30 second and thickness of the polymer solution was 40 micron membrane was precipitated in 2% aqueous solution of dimethylformamide and then washed with deionised water for several times, ultra filtration membrane so prepared was used for the preparation of nanofiltration membrane, nanofiltration membrane was prepared by interfacial polymerization technique on the top of ultra filtration membrane, by reacting polyamine and or piperazine with di or tri carboxylic acid chloride, 1-2% aqueous solution of meta phenylene diamine and 0.01 to 0.001% solution of trimesoyl chloride was taken in hexane for interfacial polymerization to prepare a very thin layer of fully cross linked aromatic polyamide polymer, more precisely 1% aqueous solution of meta phenylene diamine and 0.005% solution of trimesoyl chloride in hexane was used, contact time of ultrafilteration membrane with meta phenylene diamine solution and trimesoyl chloride solution was 60 seconds, membrane was then cured at temperature ranging between 60 to 90° C. more precisely at 65° C., membrane was then washed with 2% solution of sodium chloride for 30 minutes, membrane was then stored in deionised water, after removing from water membrane was pretreated with isopropyl alcohol for 24 hours before use.

### Fabrication of Ultrafiltration Membrane:

Polymer is dissolved in appropriate solvent in required concentration. From this solution UF membrane is prepared by wet phase inversion method on non-woven polyester fabric. Thickness of UF membrane varies from 20 to 60 microns. Since the thickness of the membrane is very less handling is difficult therefore membrane is prepared on non-woven fabric. Non-woven fabric is just a support. UF membrane is characterized by MWCO, PWP & pore sizes and pore analysis.
Large nos. of parameters are involved in the fabrication, all information is in public domain. This membrane is used as support for fabrication of nanofiltration of Reverse Osmosis membrane. For a particular membrane UF membrane of specific properties is required.

### Fabrication of Nanofiltration Membrane:

Various chemicals are used for preparation of NF & Reverse Osmosis membrane. Most common chemicals are a diamine and a di or tricarbonyl chloride. Various diamines (single or mixture) are used. Diamines are dissolved in deionised water in required concentration. Concentration varies from 0.001 to 0.01%. Various di or tri carbonyl chlorides are used. Carbonyl chlorides are dissolved in different solvents hexane is preferred. Concentration varies 0.1% to 1%. These two chemicals react on the surface of UF membrane. The polymerization technique is known as Interfacial polymerization. Many parameters are involved such as concentration of reactants, type of reactants, immersion time in both the reactants, draining times, air drying time, heat curing time, after curing treatment time and reagent, etc.
Here UF membrane is just a support. It does not take part in polymerization. Thickness of NF polyamide membrane varies from 500 A° to 1600 A°, it is too thin to be handled separately hence prepared on the support.

### DESCRIPTION OF THE DRAWING

In the drawing accompanying this specification FIG. 1. represents the Reverse Osmosis test kit on which membrane permeation experiments were conducted.

No. 1 depicts reservoir

No. 2 depicts high pressure pump

No. 3 depicts feed tube from high pressure pump to test cell

No. 4 depicts permeate collection container

No. 5 depicts channel carrying retentate from test cell to reservoir.

FIG. 2 depicts a schematic diagram of a thin film composite membrane.

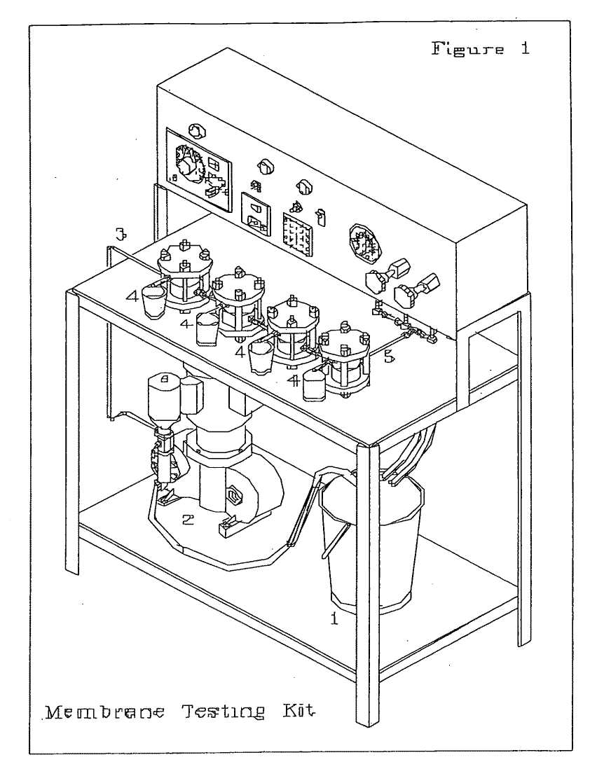

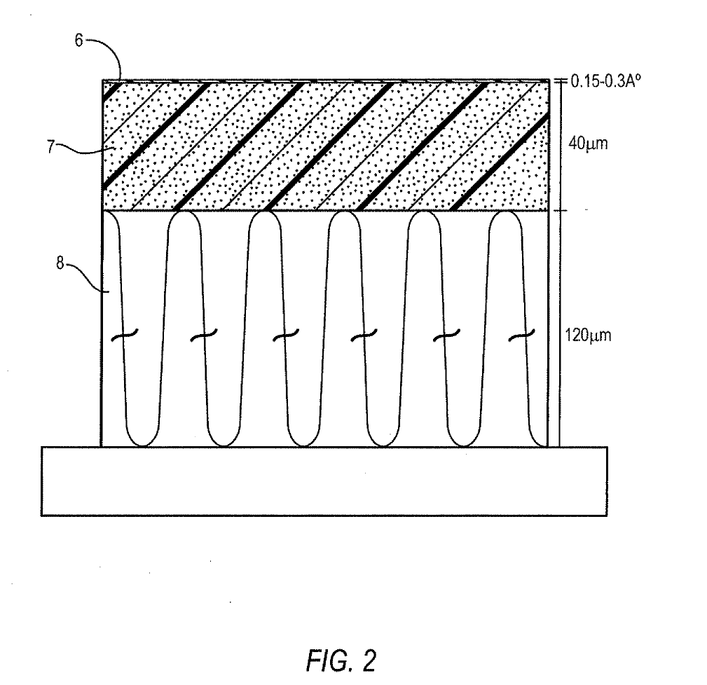

No. 6—Ultrathin barrier layer.

No. 7—microporous polysulfone.

No. 8—reinforcing fabric

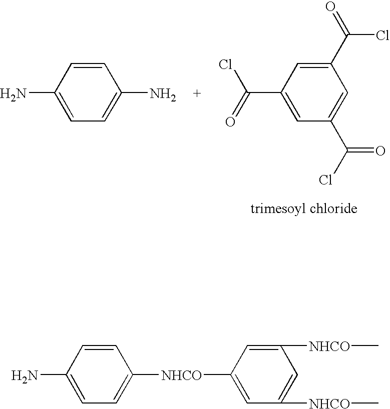

Tentative Structure of Cross Linked Aromatic Polyamide [Poly(p-phenylene trimesamide)]

The following examples are given by way of illustration and therefore should not be construed to limit the scope of the present invention

### Example 1

Nanofiltration membrane was prepared by impregnating polysulfone UF membrane in 1% aqueous solution of meta phenylene diamine for 60 seconds, draining extra solution for 60 seconds and then dipping meta phenylene diamine coated UF membrane in 0.005% solution of trimesoyl chloride in hexane for 60 seconds, extra solution was drained for 60 seconds, drying the membrane for 5 minutes in air, then membrane was heat cured for 5 minutes at 67° C. temperature, membrane was then cooled to ambient temperature and soaked in deionised water for 24 hrs.

### Example 2

Nanofiltration membrane was prepared by impregnating polysulfone UF membrane in 1.5% aqueous solution of meta phenylene diamine for 60 seconds, draining extra solution for 60 seconds and then dipping meta phenylene diamine coated UF membrane in 0.005% solution of trimesoyl chloride in hexane for 60 seconds, extra solution was drained for 60 seconds, drying the membrane for 5 minutes in air, then membrane was heat cured for 5 minutes at 67° C. temperature, membrane was then cooled to ambient temperature and soaked in deionised water for 24 hrs.

### Example 3

Nanofiltration membrane was prepared by impregnating polysulfone UF membrane in 1+0.5% aqueous solution of meta phenylene diamine and piperazine amine for 60 seconds, draining extra solution for 60 seconds and then dipping meta phenylene diamine coated UF membrane in 0.005% solution of trimesoyl chloride in hexane for 60 seconds, extra solution was drained for 60 seconds, drying the membrane for 5 minutes in air, then membrane was heat cured for 5 minutes at 67° C. temperature, membrane was then cooled to ambient temperature and soaked in deionised water for 24 hrs

### Example 4

Rice Bran Oil having phospholipids content 0.960%, free fatty acids less than 3% was treated in membrane unit fitted with cross linked polyamide based nanofiltration membrane at 600 psi pressure and 30° C. temperature, oil was permeated at flow rate of 4 gallon per square feet membrane area per day and permeated oil has phospholipids content less then 0.040% and ˜90% less color compare to feed oil.

### Example 5

Rice Bran Oil having phospholipids content 0.600%, and free fatty acids 3.6% was treated in membrane unit fitted with cross linked polyamide based nanofiltration membrane which was pretreated with for 4 hrs. before use at 600 psi pressure and 30° C. temperature, oil was permeated at flow rate of 4.5 gallon per square feet membrane area per day and permeated oil has phospholipids content less then 0.030% and ˜90% less color compare to feed oil.

### Example 6

Rice Bran Oil having phospholipids content 0.960%, free fatty acids less than 3% was treated in membrane unit fitted with cross linked polyamide based nanofiltration membrane at 300 psi pressure and 25° C. temperature, oil was permeated at flow rate of 0.8 gallon per square feet membrane area per day and permeated oil has phospholipids content less then 0.10% and ˜90% less color compare to feed oil.

### Example 7

Rice Bran Oil having phospholipids content 0.900%, free fatty acids less than 3% was treated in membrane unit fitted with cross linked polyamide based nanofiltration membrane at 300 psi pressure and 30° C. temperature, oil was permeated at flow rate of 2 gallon per square feet membrane area per day and permeated oil has phospholipids content less then 0.050% and ˜90% less color compare to feed.

### Example 8

Rice Bran Oil having phospholipids content 0.960%, free fatty acids less than 3% was treated in membrane unit fitted with cross linked polyamide based nanofiltration membrane at 300 psi pressure and 25° C. temperature, oil was permeated at flow rate of 0.9 gallon per square feet membrane area per day and permeated oil has phospholipids content less then 0.050% and ˜90% less color compare to feed.

### Example 9

Rice Bran Oil having phospholipids content 0.960%, free fatty acids less than 3% was treated in membrane unit fitted with cross linked polyamide based nanofiltration membrane at 300 psi pressure and 25° C. temperature, oil was permeated at flow rate of 0.9 gallon per square feet membrane area per day and permeated oil has phospholipids content less then 0.10% and ˜90% less color compare to feed.

### Example 10

Rice Bran Oil having phospholipids content 0.960%, free fatty acids less than 3% was treated in membrane unit fitted with cross linked polyamide based nanofiltration membrane at 300 psi pressure and 25° C. temperature, oil was permeated at flow rate of 0.9 gallon per square feet membrane area per day and permeated oil has phospholipids content less then 0.20% and ˜80% less color compare to feed.

### ADVANTAGES OF THE INVENTION

It obviates the preparation of miscella by mixing oil with non-aqueous solvent before processing the oil and to recover the solvent after processing of oil by membrane
The present invention provides an energy efficient and eco-friendly process for refining the edible oils.
The present invention provides a method for degumming the oil without any treatment of oil with chemicals such as phosphoric acid, sulphuric acid etc.
It would save precious oil that is lost during conventional degumming by way of entrapment of oil in the soap stock formed during the conventional refining and in the bleaching earth during bleaching of the oil.
It would save energy as conventional process consumes enormous amounts of energy in the form of steam and electricity to heat and cool the oil in various stages of oil refining. It would not generate acidic and basic wash waters and spent bleaching earth which is usually generated in conventional process.

We claim:

1. A polyamide nanofiltration membrane comprising, a polyamide layer coated ultrafiltration membrane characterized in that the said polyamide layer is a polymer of amine and trimeosyl chloride having a thickness in the range of 500 to 1600 Å.

2. A product as claimed in claim 1, wherein the ultrafiltration membrane used is selected from the group consisting of polysulfone, polyethersulfone, polyvinylidienefluoride, polycarbonate and polyamide UF membrane.

3. A product as claimed in claim 2, wherein the ultrafiltration membrane used has a thickness of 20 to 60 microns.

4. A product as claimed in claim 1, wherein the amine monomer used for polymerization with trimeosyl chloride is selected from metaphenylene diamine, piperazine and a mixture thereof.

5. A polyamide nanofiltration membrane as claimed in claim 1 has the following characteristics:
a) the polyamide layer has a thickness of 500 to 1600 Å,
b) permeability of nanofiltration membrane for rice bran oil is in the range of 0.8 to 5 gallon per square feet membrane area per day.

6. A product as claimed in claim 1, wherein the nanofiltration membrane obtained is useful for the removal of about 90% phospholipids from rice bran oil.

7. A process for the preparation of polyamide nanofiltration membrane, comprising the steps of:
a) impregnating the ultrafiltration membrane in 1-2% aqueous solution of amine monomer, for a period of about 60 seconds, removing the impregnated UF membrane from the solution mixture and draining the excess solution from the said UF membrane for about 60 seconds to retain the desired amount of monomer,
b) dipping the above said amine monomer coated UF membrane into 0.004 to 0.006% non aqueous solution of trimeosyl chloride for polymerization, for a period of about 60 seconds, removing the resultant polymer coated UF membrane from the solution mixture and draining the excess solution from it for a period of about 60 seconds, followed by drying for about 5 minutes and curing it by heating, at a temperature of 60-70° C., for a period of about 5 minutes, cooling the resultant membrane and soaking it in water for about 24 hours to obtain the desired product.

8. A process as claimed in claim 7, wherein the ultrafiltration membrane used in step (a) is selected from the group consisting of polysulfone, polyethersulfone, polyvinylidienefluoride, polycarbonate and polyamide UF membrane.

9. A process as claimed in claim 7, wherein the ultrafiltration membrane used in step (b) has a thickness in the range of 20 to 60 microns.

10. A process as claimed in claim 7, wherein the polyamide layer in nanofiltration membrane obtained has a thickness in the range of 500 to 1600 Å.

11. A process as claimed in claim 7, wherein the nanofiltration membrane obtained is useful for the removal of 90 to 95% of phospholipids from the rice bran oil.

12. A process as claimed in claim 7, wherein the nanofiltration membrane obtained is useful for the removal of 80-90% pigments from the rice bran oil.

13. A process for the removal of phospholipids from the rice bran oil by using nanofiltration membrane which comprises feeding the rice bran oil without any diluting with aqueous or non aqueous solvent to a nanofiltration membrane, at a flow rate of 0.8 to 5 gallon per square feet/day, at a pressure of 300 to 600 psi, at a temperature of about 25 to 30° C. to obtain the desired 90 to 95% phospholipids free rice bran oil.

14. A process as claimed in claim 13, wherein the nanofiltration membrane used comprises a polyamide layer coated ultrafiltration membrane characterized in that the said polyamide layer has a thickness in the range of 500 to 1600 Å.

15. A process as claimed in claim 13, wherein the ultrafiltration membrane used is selected from the group consisting of polysulfone, polyethersulfone, polyvinylidienefluoride, polycarbonate and polyamide UF membrane.

16. A process as claimed in claim 13, wherein the ultrafiltration membrane used has a thickness in the range of 20 to 60 microns.
